(19) United States
(12) Patent Application Publication
(10) Pub. No.: US 2017/0277539 A1
(43) Pub. Date: Sep. 28, 2017

(54) EXCEPTION HANDLING IN PROCESSOR USING BRANCH DELAY SLOT INSTRUCTION SET ARCHITECTURE

(71) Applicant: Imagination Technologies Limited, Kings Langley (GB)

(72) Inventor: James Robinson, New York, NY (US)

(21) Appl. No.: 15/079,784

(22) Filed: Mar. 24, 2016

(51) Int. Cl. G06F 9/30

(52) U.S. Cl. CPC G06F 9/30058; G06F 9/30145

(57) ABSTRACT

A processor employs hardware to save the program counter value of the next instruction to be executed in a branch instruction when an exception occurs. This is the branch target address in the case where the exception occurs in the delay slot of a taken branch. The value is saved to a register when an exception occurs. The kernel code can then read the register to determine the address which it should return to after an exception. This eliminates the need to emulate the branch instruction and also eliminates the need to keep the kernel up to date with the knowledge of how to emulate all branches in an Instruction Set Architecture.

### BACKGROUND

Branches in the known MIPS (Microprocessor without Interlocked Pipeline Stages) Instruction Set Architecture may have branch delay slots. This means that the instruction immediately after the branch is executed before control transfers to the branch target address. If the instruction after the branch takes an exception, it may be necessary for the kernel to emulate that instruction then return to the target address of the branch. In current processors, when this situation occurs, the hardware only records the program counter (PC) address and opcode of the branch before the exception. So in order to determine the branch target address, the kernel must decode the opcode to find the branch type and target address and determine whether or not the branch is taken by reading and testing the relevant input registers. This has the disadvantage of requiring additional computational cycles when running code.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A processor employs hardware to save the program counter value of the next instruction to be executed, in a branch instruction for example, when an exception occurs. This is the branch target address in the case where the exception occurs in the delay slot of a taken branch. The value is saved to a register when an exception occurs. The kernel code can then read the register to determine the address which it should return to after an exception. This eliminates the need to emulate the branch instruction and also eliminates the need to keep the kernel up to date with the knowledge of how to emulate all branches in an Instruction Set Architecture. Also, the software exception handler can be simplified.

The next instruction address (or “next PC”) is stored in a software visible register when an exception occurs. It will be appreciated that this stored address is not a predicted address, but a bona fide target address as computed by the processor.

A first aspect provides a computer-implemented method comprising, in a processor: fetching an instruction of a sequence of instructions, each instruction in the sequence of instructions having a computable address associated therewith; detecting whether an exception has occurred in respect of the fetched instruction; in response to detecting that an exception has occurred for the fetched instruction, storing in a register the computed address of the next instruction following the fetched instruction in the sequence of instructions, completing an exception handling process, and after completion of the exception handling process, reading from the register the stored address of the next instruction, and executing the next instruction.

An instruction which immediately precedes the fetched instruction may be a branch instruction. In such a case, the branch instruction may have a branch delay slot in which the fetched instruction which raises an exception is executed. The stored address of the next instruction is then the branch target address.

A second aspect provides a processor including a register, the processor configured to fetch an instruction of a sequence of instructions, each instruction in the sequence of instructions having a computable address associated therewith, store in the register the computed address of the next instruction following the fetched instruction in the sequence of instructions if an exception occurs in respect of the fetched instruction, and after completion of an exception handling process, read from the register the stored address of the next instruction for execution.

Reading the stored address of the next instruction from the register may be performed by kernel code running on the processor.

The processor may be embodied in hardware or an integrated circuit. There may be provided a method of manufacturing, at an integrated circuit manufacturing system, the processor. There may be provided an integrated circuit definition dataset that, when processed in an integrated circuit manufacturing system, configures the system to manufacture the processor. There may be provided a non-transitory computer readable storage medium having stored thereon a computer readable description of an integrated circuit that, when processed in an integrated circuit manufacturing system, causes the integrated circuit manufacturing system to manufacture the processor.

There may be provided an integrated circuit manufacturing system comprising: a non-transitory computer readable storage medium having stored thereon a computer readable integrated circuit description that describes the processor; a layout processing system configured to process the integrated circuit description so as to generate a circuit layout description of an integrated circuit embodying of a processor; and an integrated circuit generation system configured to manufacture the processor according to the circuit layout description.

There may be provided computer readable code adapted to perform the steps of the method of the first aspect. Also there may be provided a non-transitory computer readable storage medium having stored thereon computer readable instructions that when executed in a computer system cause the computer system to perform the method of the first aspect.

The above features may be combined as appropriate, as would be apparent to a skilled person, and may be combined with any of the aspects of the examples described therein.

### BRIEF DESCRIPTION OF THE DRAWINGS

Examples will now be described in detail with reference to the accompanying drawings, in which:

FIG. 1 is a simplified, schematic block diagram of an example processor;

FIG. 2 is a flow diagram illustrating an example method of operation of the processor of FIG. 1; and

FIG. 3 shows an example of an integrated circuit manufacturing system.

Common reference numerals are used throughout the figures to indicate similar features.

The accompanying drawings illustrate various examples. The skilled person will appreciate that the illustrated element boundaries (for example, boxes, groups of boxes or other shapes) in of the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only

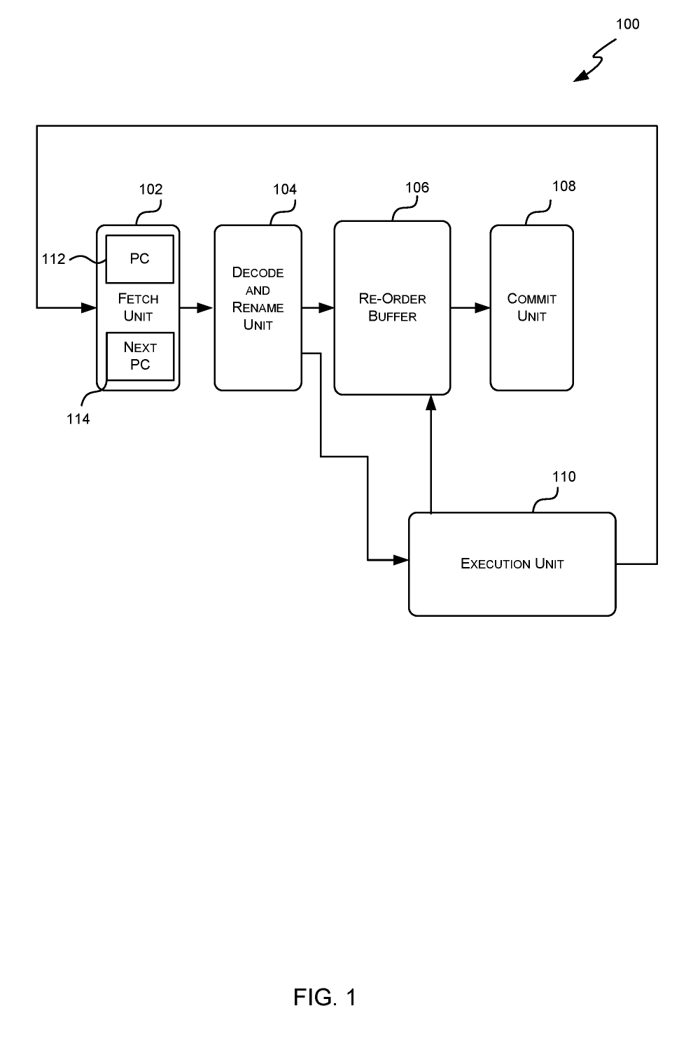

FIG. 1 shows a schematic diagram of part of an example processor 100 in which the methods described herein may be implemented. In this example the processor 100 is a single-threaded processor, however the methods are also applicable to multi-threaded processors.

Although FIG. 1 shows an out-of-order processor, the methods may also be implemented in a processor which does not process instructions out-of-order, i.e. in an in-order processor.

The processor 100 comprises a fetch unit 102, a decode and rename unit 104, a re-order buffer 106, a commit unit 108 and one or more execution units 110 which each comprise one or more execution pipelines. It will be evident to a person of skill in the art that one or more of these units may be combined. For example, in other processors the decode and renaming unit 104 and the one or more execution units 110 may be combined to form a single unit.

The fetch unit 102 is configured to fetch instructions from a program (in program order) as indicated by program counter (PC) 112. A program counter is a register that holds the address of the current instruction being executed and an adder increments the PC to the address of the next instruction. When instructions are executed sequentially, the address of the next instruction can be computed as the address of the current instruction plus a fixed offset (e.g. the length of an instruction). In the case of sequential execution, the address of the next instruction can be computed in the fetch unit 102. In the case of non-sequential execution, the address of the next instruction can be computed in an execution unit (to be described below).

Some fetch units 102 are configured to fetch more than one instruction in a cycle while other fetch units are configured to fetch only a single instruction in a cycle. When multiple instructions are fetched in a cycle the instructions are said to form an instruction bundle. The term “cycle” means a processing cycle of the processor 100. In some cases there is a processing cycle each clock cycle. However, in other cases processing cycles may occur more or less often than each clock cycle. The fetch unit 102 also includes a “next PC” register 114 whose function will be described below.

Once an instruction or instruction bundle is fetched the instructions contained therein are provided to the decode and rename unit 104 which is arranged to interpret the instructions and perform register renaming. In particular, each instruction may comprise a register write operation; one or more register read operations; and/or an arithmetic or logical operation. A register write operation writes to a destination register (not shown) and a register read operation reads from a source register (not shown). During register renaming each architectural register referred to in an instruction (e.g. each source and destination register) is replaced (or renamed) with a physical register.

After an instruction passes through the decode and rename unit 104 it is inserted into reorder buffer 106 and dispatched to execution unit 110 for execution. The execution unit 110 that the instruction is dispatched to may be based on the type of instruction to be executed.

The re-order buffer 106 is a buffer that enables the instructions to be executed out-of-order, but committed in-order. The re-order buffer 106 holds the instructions that are inserted into it in program order, but the instructions within the re-order buffer 106 can be executed out of sequence by the execution unit[s] 110. Instructions output from the re-order buffer 106 are provided to a commit unit 108, which commits the results of the instructions to the register or memory (not shown).

Each execution unit 110 is responsible for executing instructions and may be configured to execute specific types of instructions. Each execution unit 110 may comprise one or more of a load-store unit, an integer unit, a floating point unit (FPU), a digital signal processing (DSP)/single instruction multiple data (SIMD) unit, or a multiply accumulate (MAC) unit. The load-store unit reads data to and writes data from the L1 cache and memory (not shown) beyond that. An integer unit performs integer instructions, an FPU executes floating point instructions, a DSP/SIMD unit has multiple processing elements that perform the same operation on multiple data points simultaneously, and a MAC unit computes the product of two numbers and adds that product to an accumulator.

The processor 100 may also comprise functional elements other than those shown in FIG. 1 (e.g. caches, memory, register files, etc.). For example, the processor 100 may further comprise a branch predictor which is configured to predict which direction the program flow will take in the case of instructions known to cause possible flow changes, such as branch instructions. The branch target address is the address specified in a branch which becomes the new PC if that branch is taken. In MIPS architecture the branch target address is the address of the instruction following the branch plus the offset field of the instruction. As mentioned above, some branches may have delay slots. The branch delay slot is the slot directly after a delayed branch instruction and in MIPS architecture is filled by an instruction that does not affect the branch. The branch target address is then the instruction immediately following the delay slot instruction.

The processor may also comprise exception detection hardware. This may reside in different parts of the processor 100 according to the type of exception being detected. For example the fetch unit 102, decode and rename unit 104 and execution unit 110 may include such exception detection hardware. On detection of an exception, the PC 112 is updated to one of a specific set of addresses where exception handling is stored in memory. Exception handling software typically examines the cause of the exception as indicated by state stored in hardware registers and jumps to an appropriate point in the operating system which is running on the processor 100.

It will be appreciated that other processors may not comprise all the functional elements shown in FIG. 1 (i.e. one or more of the functional elements shown in FIG. 1 may be omitted) and may, in some examples, comprise additional functional elements not shown in FIG. 1. Furthermore, the ‘next PC’ register 114 may be located elsewhere in the processor 100 (other than in the fetch unit 102).

There may be instances where the next instruction following a branch instruction raises an exception. An exception is an event (other than a jump or a branch) that changes the normal flow of instruction executions. Examples of exceptions are a hardware malfunction, a cache error (that is an error in reading a cache) or the use of an undefined instruction, the use of an instruction that is defined but not supported on the processor, or the use of a valid instruction using unsupported input values. An exception has to be dealt with before the processor can go back to the point at which the exception was raised or to the next instruction in the program if the exception-causing instruction needs to be skipped.

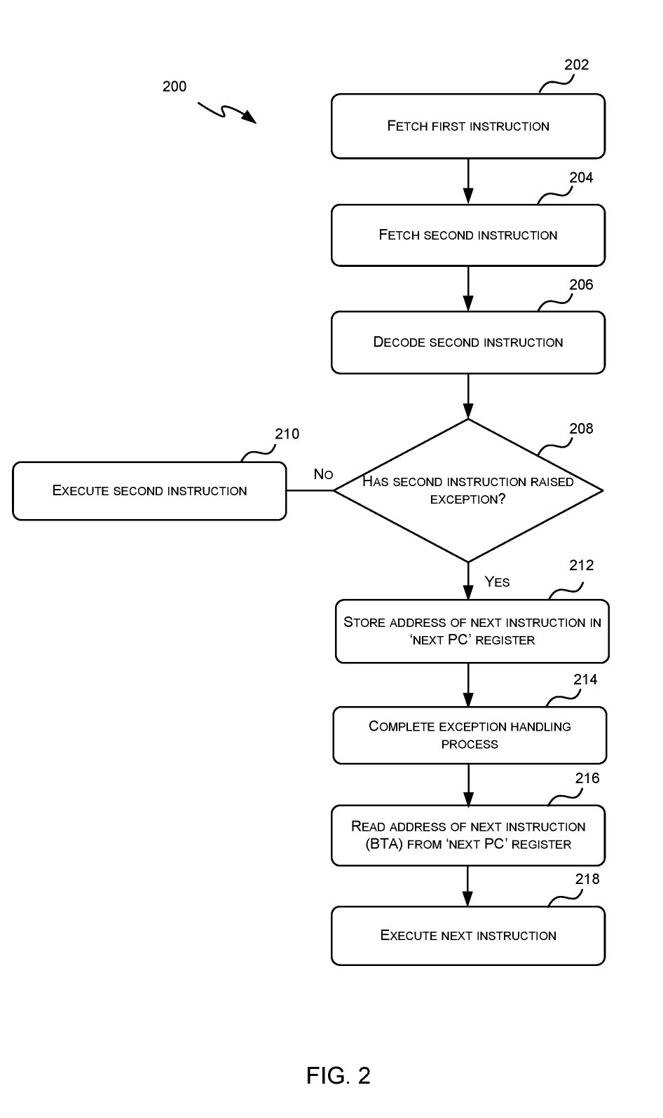

Methods for determining an address to return to after an exception will now be described with reference to the flow diagram of FIG. 2 which illustrates an example method 200.

At 202, a first instruction is fetched by the fetch unit 102. In this example, this first instruction is a branch instruction having a branch delay slot.

At 204, a second instruction is fetched by the fetch unit 102 for execution in the branch delay slot.

At 206, the second instruction is decoded in the decode and re-name unit 104.

At 208, it is determined whether or not the second instruction has raised an exception. If no exception has occurred, then at 210 the second instruction can be executed and the process can continue as normal. If, on the other hand an exception has occurred, then at 212 the computed address of the next instruction (that is the one following the second instruction, and in this example the branch target address) is stored in the “next PC” register 114. Also, at 214 an exception handling process is initiated and completed.

At 216 the stored branch target address (BTA) is read from the ‘next PC’ register 114. The branch target address is thus a visible to the software of the processor 100 and is read by the kernel code of the processor (the kernel being a program or function for one thread designed to be executed by many threads).

At 218, the process can continue with the execution of the next instruction fetched from the branch target address.

While the above example method has been described for the case where the branch has a branch delay slot, the method is equally applicable to branches without delay slots. Furthermore, the method is applicable for any type of exception that may occur which may or may not follow a branch instruction.

The processor described herein may be embodied in hardware or an integrated circuit. The processor described herein may be configured to perform any of the methods described herein. Generally, any of the functions, methods, techniques or components described above can be implemented in software, firmware, hardware (e.g. fixed logic circuitry) or any combination thereof. The terms “module,” “functionality,” “component,” “element,” “unit,” “block” and “logic” may be used herein to generally represent software, firmware, hardware or any combination thereof. In the case of a software implementation, the module, functionality, component, element, unit, block or logic represents program code that performs the specified tasks when executed on a processor. The methods described herein could be performed by one or more processors executing code that causes the processors to perform the methods. Examples of a computer-readable storage medium include a random-access memory (RAM), read-only memory (ROM) or optical disc, flash memory, hard disc memory and other memory devices that may use magnetic, optical and other techniques to store instructions or other data and that can be accessed by a machine.

The term computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist) and code expressed in a programming language such as C, Java or OpenCL. Executable code may be, for example, any kind of software, firmware, script, module or library which, when suitably executed, processed, interpreted, compiled, executed at a virtual machine or other software environment, causes a processor of the computer system at which the executable code is supported to perform the tasks specified by the code.

A processor, computer, or computer system may be any kind of device, machine or dedicated circuit or collection or portion thereof with processing capability such that it can execute instructions. A processor may be any kind of general-purpose or dedicated processor, such as CPU, GPU. System-on-chip, state machine, media processor, an application-specific integrated circuit (ASIC), a programmable logic array, a field-programmable gate array (FPGA) or the like. A computer or computer system may comprise one or more processors.

It is also intended to encompass software which defines a configuration of hardware as described herein, such as HDL (hardware description language) software, as is used for designing integrated circuits or for configuring programmable chips to carry out desired functions. That is, there may be provided a computer readable storage medium having encoded thereon computer readable code in the form of an integrated circuit definition data set that when processed in an integrated circuit manufacturing system configures the system to manufacture a processor configured to perform any of the methods described herein or to manufacture a processor comprising any apparatus described herein. An integrated definition dataset may be, for example, an integrated circuit description.

An integrated circuit definition dataset may be in the form of computer code, for example as a netlist, code for configuring a programmable chip, as a hardware description language defining an integrated circuit at any level, including as register transfer level (RTL) code, as high-level circuit representations such as Verilog or VHDL, and as a low-level circuit representations such as OASIS (RTM) and GDSII. Higher level representations which logically define an integrated circuit (such as RTL) may be processed at a computer system configured for generating a manufacturing definition of an integrated circuit in the context of a software environment comprising definitions of circuit elements and rules for containing those elements in order to generate the manufacturing definition of an integrated circuit as defined by the representation. As is typically the case with software executing at a computer system so as to define a machine, one or more indeterminate user steps (e.g. providing commands, variables etc.) may be required in order for a computer system configured for generating a manufacturing definition of an integrated circuit to execute code defining an integrated circuit so as to generate the manufacturing definition of that integrated circuit.

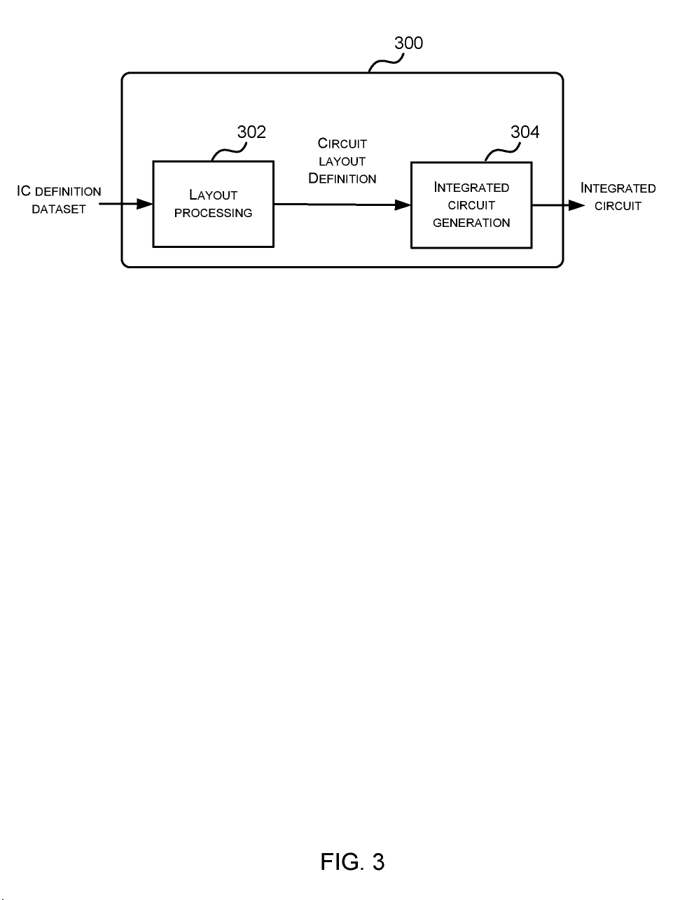

An example of processing an integrated circuit definition dataset at an integrated circuit manufacturing system so as to configure the system to manufacture a processor will now be described with respect to FIG. 3.

FIG. 3 shows an example of an integrated circuit (IC) manufacturing system 300 which comprises a layout processing system 302 and an integrated circuit generation system 304. The IC manufacturing system 300 is configured to receive an IC definition dataset (e.g. defining a processor as described in any of the examples herein), process the IC definition dataset, and generate an IC according to the IC definition dataset (e.g. which embodies a processor as described in any of the examples herein). The processing of the IC definition dataset configures the IC manufacturing system 300 to manufacture an integrated circuit embodying a processor as described in any of the examples herein.

The layout processing system 300 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 302 has determined the circuit layout it may output a circuit layout definition to the IC generation system 304. A circuit layout definition may be, for example, is circuit layout description

The IC generation system 304 generates an IC according to the circuit layout definition, as is known in the art. For example, the IC generation system 304 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 304 may be in the form of computer-readable code which the IC generation system 304 can use to form a suitable mask for use in generating an IC.

The different processes performed by the IC manufacturing system 300 may be implemented all in one location, e.g. by one party. Alternatively, the IC manufacturing system 300 may be a distributed system such that some of the processes may be performed at different locations, and may be performed by different parties. For example, some of the stages of: (i) synthesizing RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a processor without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 3 by an integrated circuit manufacturing definition dataset may cause a device as described herein to be manufactured.

In some examples, an integrated circuit definition dataset could include software which runs on hardware defined by the dataset or in combination with hardware defined by the dataset. In the example shown in FIG. 3, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1. A method of executing instructions in a processor, comprising:
fetching an instruction of a sequence of instructions, each instruction in the sequence of instructions having a computable address associated therewith;
detecting that an exception has occurred in respect of the fetched instruction; and
in response to detecting that an exception has occurred for the fetched instruction, storing in a register the computed address of the next instruction following the fetched instruction in the sequence of instructions, completing an exception handling process, and after completion of the exception handling process, reading from the register the stored address of the next instruction, and executing the next instruction.

2. A method according to claim 1 wherein an instruction immediately preceding the fetched instruction is a branch instruction.

3. A method according to claim 2 wherein the branch instruction has a branch delay slot in which the fetched instruction which raises an exception is executed.

4. A method according to claim 3 wherein the stored address of the next instruction is a branch target address.

5. A method according to claim 1 wherein reading from the register the stored address of the next instruction is performed by kernel code comprising part of an operating system configured to run on the processor.

6. A processor including a register, the processor configured to:
fetch an instruction of a sequence of instructions, each instruction in the sequence of instructions having a computable address associated therewith,
store in the register the computed address of the next instruction following the fetched instruction in the sequence of instructions if an exception occurs in respect of the fetched instruction, and
after completion of an exception handling process, read from the register the stored address of the next instruction for execution.

7. The processor of claim 6 wherein the processor is embodied in hardware or an integrated circuit.

8. A non-transitory computer readable storage medium having stored thereon computer readable instructions that when executed in a computer system cause the computer system to:
fetch an instruction of a sequence of instructions, each instruction in the sequence of instructions having a computable address associated therewith;
detect that an exception has occurred in respect of the fetched instruction; and
in response to detecting that an exception has occurred for the fetched instruction, store in a register the computed address of the next instruction following the fetched instruction in the sequence of instructions, complete an exception handling process, and after completion of the exception handling process, read from the register the stored address of the next instruction, and execute the next instruction.

9. A non-transitory computer readable storage medium having stored thereon a computer readable description of an integrated circuit, that when processed in an integrated circuit manufacturing system, causes the integrated circuit manufacturing system to manufacture a processor, the processor including a register, the processor configured to fetch an instruction of a sequence of instructions, each instruction in the sequence of instructions having a computable address associated therewith, store in the register the computed address of the next instruction following the fetched instruction in the sequence of instructions if an exception occurs in respect of the fetched instruction, and after completion of an exception handling process, read from the register the stored address of the next instruction for execution.

10. (canceled)

11. (canceled)

12. (canceled)

13. (canceled)

14. A non transitory machine readable storage medium having stored thereon an integrated circuit definition dataset that, when processed in an integrated circuit manufacturing system, configures the system to manufacture a processor as claimed in claim 6.

15. The non-transitory machine readable storage medium according to claim 14, wherein the processor is embodied in hardware.

16. The non-transitory machine readable storage medium according to claim 14, wherein the processor is embodied in an integrated circuit.
